(19) United States
(12) Patent Application Publication
(10) Pub. No.: US 2024/0235245 A9
(43) Pub. Date: Jul. 11, 2024

(54) THREE-PHASE AND SINGLE-PHASE TWO-WAY CHARGER

(71) Applicant: FOUNDATION FOR RESEARCH AND BUSINESS, SEOUL NATIONAL UNIVERSITY OF SCIENCE AND TECHNOLOGY, Seoul (KR)

(72) Inventor: Se Wan CHOI, Seoul (KR)

(73) Assignee: FOUNDATION FOR RESEARCH AND BUSINESS, SEOUL NATIONAL UNIVERSITY OF SCIENCE AND TECHNOLOGY, Seoul (KR)

(21) Appl. No.: 18/264,065

(22) PCT Filed: Aug. 19, 2021
(86) PCT No.: PCT/KR2021/011039

§ 371 Date: Aug. 2, 2023

(30) Foreign Application Priority Data
Feb. 26, 2021 (KR) 10-2021-0026818
Mar. 12, 2021 (KR) 10-2021-0032670

(51) Int. Cl. H02J 7/06

(52) U.S. Cl. CPC H02J 7/06; B60L 53/20; B60L 2210/30; H02J 2207/20

(57) ABSTRACT

The present technology discloses a three-phase and single-phase two-way charger. According to a specific example of the present invention, a battery charger having a single-stage structure for a combined use of single-phase and three-phase is implemented without an electrolytic capacitor which lowers the reliability and charging efficiency, to enable a compatible use of single-phase and three-phase external power sources, and to improve charging efficiency and the performance in a wide input/output voltage range by a reduced number of switching elements and a soft switching operation of the switching elements and thus improve the reliability and lifetime. A lightweight charger can be realized by integrating, into a core, at least two of an inductor for removing ripples of the battery charger, a primary side and a secondary side of a transformer, and an inductor for removing noise.

### TECHNICAL FIELD

The present disclosure relates to a three-phase and single-phase two-way charger and, more particularly, to a technology capable of improving charging efficiency and reducing the price and volume of an electric vehicle battery charger by including an integrated-type core and a single-stage circuit without electrolytic capacitors.

### BACKGROUND ART

Recently, as international markets for electric vehicles have been established in earnest, the need for development of single-phase/three-phase combined use with a wide voltage range is increasing to satisfy various system voltages and types for each country.

As a structure of electric vehicle on-board chargers, a modular 2-stage structure is currently the widely used type, but there are problems in that such a structure has limitations in power density and efficiency due to a large number of elements provided therein, and has a bulky volume and a short service life thereof due to the use of electrolytic capacitors for single-phase/three-phase operation. Due to such conventional circuit limitations, a circuit having a single-stage structure without electrolytic capacitors has recently been proposed.

Recently, an electric vehicle on-board charger using a method of single-stage structure without electrolytic capacitors of a single-phase/three-phase On Board Charger (OBC) have achieved high efficiency and power density with a small number of elements. However, due to the characteristics of a single-stage dual active bridge (DAB) circuit, performance is not good in a wide input/output voltage range, and a separate decoupling circuit is required for single-phase operation.

In addition, as shown in FIG. 1, a conventional charger requires many magnetic bodies, such as inductors Lₛ₁ and Lₛ₂ of a ripple removal unit 110, a transformer 141, inductors L_{g1} and L_{g2} of a noise removal unit 142, and the like, and accordingly there are weak points of increasing the volume and manufacture cost of the charger.

### DISCLOSURE

### Technical Problem

An objective of the present disclosure is to provide a three-phase and single-phase two-way charger in which the number of switching elements is reduced and high efficiency, high density, and high reliability are provided by implementing an AC-DC converter as a single-stage circuit without electrolytic capacitors.

Accordingly, unlike the conventional single-stage circuit, the charger of the present disclosure has high performance even in a wide input/output voltage range, and is configured with a power decoupling circuit without a separate additional switching element to enable direct current(DC) charging of a battery.

Accordingly, a plurality of cores of a three-phase and single-phase two-way charger is formed by integration on one plate, so as to reduce the price and volume of an electric vehicle charger applied with a three-phase and single-phase combined AC-DC converter, whereby a lightweight charger may be provided.

The objectives of the present disclosure is not limited to the above-mentioned objectives, and other objectives and strong points of the present disclosure not mentioned above can be understood by the following description, and can be more clearly understood by the exemplary embodiments of the present disclosure. Further, it will be readily apparent that the objectives and strong points of the present disclosure may be realized by the means and combinations thereof indicated in the appended claims.

### Technical Solution

According to an exemplary embodiment of the present disclosure, there is provided a three-phase and single-phase two-way charger, the charger including: first to third modules configured to convert respective three-phase external power into a high-voltage direct current form and then charge a battery, and further comprising: a first relay switch for transmitting single-phase external power to the second module; and a second relay switch for blocking the transmitting of the single-phase external power to the third module.

Preferably, the three-phase and single-phase two-way charger may be provided to supply the respective three-phase external power to each of the first to third modules by the first relay switch controlled to be opened and the second relay switch controlled to be closed with respect to the three-phase external power, and may be provided to supply the single-phase external power to each of the first to second modules and to block the supply of the single-phase external power to the third module by the first relay switch controlled to be closed and the second relay switch controlled to be opened with respect to the single-phase external power.

Preferably, each of the modules may include: a ripple removal unit provided with inductors connected in parallel to a first end of an external power supply, which is supplied through the first and second relay switches, to remove a ripple component of the external power; an inverter connected to an output terminal of the ripple removal unit to convert the external power of low frequency component into an alternating current form of high frequency component; a capacitor for half-wave rectifying an alternating current component of an output signal of the inverter; a transformer connected to an output terminal of the capacitor to pass an output signal of the capacitor; a noise removal unit provided with inductors respectively connected to a first end and a second end of a secondary side of the transformer to remove a noise component included in an output signal of the secondary side of the transformer; an AC-DC converter connected to an output terminal of each inductor of the noise removal unit to convert an output signal of each inductor into the direct current form; and a filter provided as a capacitor connected between a first end and a second end of the AC-DC converter to remove a noise component included in an output signal of the AC-DC converter and then charge the output signal of high frequency component to the battery.

Preferably, the third module may further include: a decoupler for controlling an output signal of the filter with respect to the single-phase external power.

The decoupler may include: a third relay switch connected in series to a center tap of the secondary side of the transformer to decouple an output terminal of the secondary side of the transformer and the battery; and an energy-regulating capacitor for charging and discharging a low frequency component of the output signal of the filter.

Preferably, in the decoupler, the output signal of the filter of the third module may be supplied to the battery by the third relay switch controlled to be opened in accordance with a control signal supplied from an outside with respect to the three-phase external power.

Preferably, the decoupler may be provided to remove a charging voltage of the filter and deactivate the transformer in accordance with a short circuit of switching elements of the inverter as the third relay switch is controlled to be closed in accordance with a control signal supplied from an outside with respect to the single-phase external power and the charging voltage of the filter is transmitted to the energy-regulating capacitor via the AC-DC converter performing interleaving with a switching operation of 180-degree phase shift.

Preferably, the decoupler may be provided to remove a charging voltage of the filter of low frequency component and deactivate the transformer in accordance with a same-phase switching operation of the AC-DC converter as the third relay switch is controlled to be closed in accordance with a control signal supplied from an outside with respect to the single-phase external power and the output signal of the filter is transmitted to the energy-regulating capacitor via the AC-DC converter performing interleaving with the same-phase switching operation.

Preferably, the decoupler may include: the third relay switch connected to the first end of the secondary side of the transformer to decouple the output terminal of the secondary side of the transformer and the battery when the external power is cut off with a single-phase input; and the energy-regulating capacitor connected between the second end of the secondary side of the transformer and a second end of the third relay switch to remove a charging voltage of the filter.

Preferably, the decoupler may be provided to remove the charging voltage of the filter and deactivate the transformer in accordance with a short circuit of switching elements of the inverter as the third relay switch is controlled to be closed in accordance with a control signal supplied from an outside with respect to the single-phase external power and the charging voltage of the filter is transmitted to the energy-regulating capacitor via the switching elements of the AC-DC converter.

Preferably, the third module may include: a decoupler for controlling the output voltage of the filter with respect to the single-phase external power; and a transformer relay unit connected between the output terminal of the ripple removal unit and a second end of a primary side of the transformer.

The decoupler may include: the third relay switch connected in series to a center tap of the secondary side of the transformer to decouple the output terminal of the secondary side of the transformer and the battery; and the energy-regulating capacitor for charging and discharging a low frequency component of the output signal of the filter.

The transformer relay unit may include: a fourth relay switch connected in series between an output terminal of the ripple removal unit and a first end of the primary side of the transformer; and an inductor connected between the output terminal of the fourth relay switch and the second end of the primary side of the transformer.

The decoupler may be provided to remove a charging voltage of the filter as the third relay switch is controlled to be closed in accordance with a control signal supplied from an outside with respect to the single-phase external power and the charging signal of the filter is transmitted to the energy-regulating capacitor via the AC-DC converter performing the interleaving with a switching operation of 180-degree phase shift.

The transformer relay unit may be provided to deactivate the transformer as the fourth relay switch is switched to a closed state in accordance with the control signal with respect to the single-phase external power and an output signal of the primary side of the transformer is transmitted to the ripple removal unit via the inductors and the fourth relay switch.

Preferably, each of the modules may be provided with one core formed by integrating, into a pair of plates made of a magnetic material, at least two of the inductors of the ripple removal unit, the primary side and the secondary side of the transformer, and the inductors of the noise removal unit.

The core may be provided with the pair of plates comprising a lower plate integrally molded with both-side legs and a center leg respectively installed on both sides and in a center thereof and an upper plate attached to the center leg and connected to the lower plate to form a magnetic body, and may be provided so that the inductors of the ripple removal unit have coils respectively wound on lower sides of the both-side legs of the lower plate and the primary side and secondary side of the transformer have coils respectively wound on upper sides of the both-side legs of the lower plate.

Preferably, the core may be provided with a pair of plates configured to form a magnetic body by comprising a lower plate integrally molded with both-side legs, a center leg, and winding legs between the both-side legs and the center leg and an upper plate attached to the center leg and connected to the lower plate, and may be provided so that the inductors of the ripple removal unit have coils respectively wound on lower sides of the winding legs of the lower plate and the primary side and the secondary side of the transformer have coils respectively wound on upper sides of the winding legs of the lower plate.

Preferably, the core may be provided with a pair of plates comprising a lower plate integrally molded with both-side front legs, both-side rear legs, and one center leg and an upper plate attached to the center leg and connected to the lower plate, and may be provided so that the inductors of the ripple removal unit have coils respectively wound on lower sides of the both-side front legs of the lower plate, the primary side and the secondary side of the transformer have coils respectively wound on upper sides of the both-side front legs of the lower plate, and the inductors of the noise removal unit connected to the secondary side of the transformer have coils respectively wound on the both-side rear legs of the lower plate.

### Advantageous Effects

According to such characteristics, there are effects that a single-phase and three-phase two-way battery charger having a single-stage structure is implemented without electrolytic capacitors that reduce reliability and charging efficiency, whereby compatibility with single-phase and three-phase external power may be provided, charging efficiency and performance over a wide input/output voltage range may be improved due to the reduced number of switching elements and soft switching operation of the switching elements, and reliability and a service life may be improved.

In the conventional single-stage circuit, separate switches, inductors, capacitors, and relays are added thereto in order to add a decoupling circuit for removing secondary components. Whereas, in the embodiments of the present disclosure, a decoupling circuit may be configured by using an existing circuit and adding only relays and capacitors without adding separate switches and inductors.

In addition, there is an effect that ripple removal inductors, a primary side and a secondary side of a transformer, and noise removal inductors are integrated into one core in a battery charger, thereby realizing a lightweight charger.

### DESCRIPTION OF DRAWINGS

The following drawings attached to the present specification illustrate preferred exemplary embodiments of the present disclosure, and serve to further understand the technical spirit of the present disclosure together with the detailed description of the present disclosure to be described below, so the present disclosure should not be construed as being limited only to the matters described in the drawings.

FIG. 1 is a view illustrating a core of a general charger.

FIG. 2 is an overall circuit diagram of a charger according to an exemplary embodiment.

FIG. 3 is a conceptual view illustrating three-phase external power supplies of the charger according to the exemplary embodiment.

FIG. 4 is an output waveform diagram of each unit in FIG. 3.

FIG. 5 is a conceptual view illustrating a single-phase external power supply of the charger according to the exemplary embodiment.

FIG. 6 is an equivalent circuit diagram illustrating a third module of the charger of FIG. 5.

FIG. 7 is an output waveform diagram of each unit in FIG. 5.

FIGS. 8 and 9 are other exemplary views illustrating a decoupler of FIG. 5.

FIG. 10 is another exemplary view illustrating a third module of the charger of FIG. 2.

FIG. 11 is an exemplary view illustrating a core of the charger of the exemplary embodiment.

FIG. 12 is another exemplary view illustrating a core of the charger of the exemplary embodiment.

FIG. 13 is a yet another exemplary view illustrating a core of the charger of the exemplary embodiment.

FIG. 14 is a still another exemplary view illustrating a core of the charger of the exemplary embodiment.

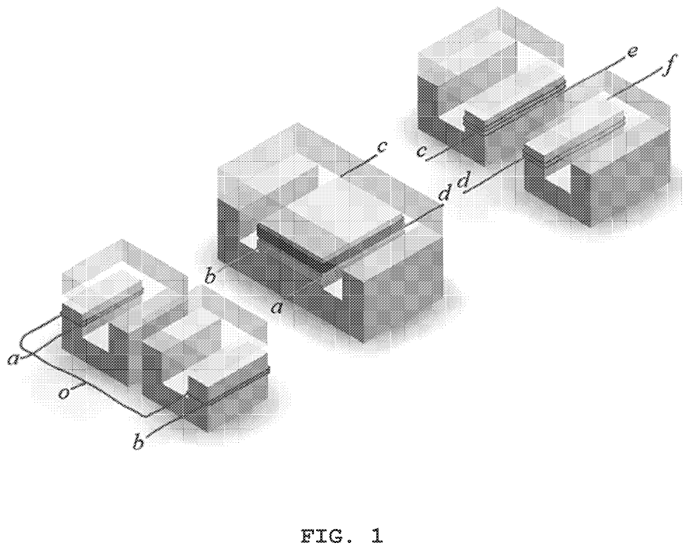

### BEST MODE

Hereinafter, exemplary embodiments of the present disclosure will be described in more detail with reference to the drawings.

Advantages and features of the present disclosure and the methods of achieving the same will become apparent with reference to exemplary embodiments described below in conjunction with the accompanying drawings. However, the present disclosure is not limited to the exemplary embodiments disclosed below, but will be implemented in a variety of different forms. These exemplary embodiments are provided only to complete the embodiments of the present disclosure and to completely inform the scope of the present disclosure to those skilled in the art to which the present disclosure pertains, and the present disclosure is only defined by the scope of the claims.

The terms used in the present specification will be briefly described, and then the present disclosure will be described in detail.

The terms used in the present disclosure have selected general terms that are currently widely used as possible while considering functions in the embodiments of the present disclosure, but this may vary according to the intention of those skilled in the art, the judicial precedent, the emergence of new technologies, etc. In addition, in certain cases, there are terms arbitrarily selected by the applicant, and in this case, the meaning of the terms will be described in detail in the description of the corresponding embodiments of the present disclosure. Therefore, the terms used in the present disclosure should be defined on the basis of the meaning of the terms and the overall contents of the present disclosure rather than on the basis of simple dictionary definitions.

Throughout the description of the present disclosure, when a part or a unit is said to “include” or “comprise” a certain component, it means that it may further include or comprise other components, without excluding other components unless the context clearly indicates otherwise. In addition, the term “part” or “unit” used in the specification means software or hardware components such as FPGA or ASIC, and the term “part” or “unit” performs certain roles. However, “part” or “unit” is not limited to software or hardware. The term “part” or “unit” may be configured to reside in an addressable storage medium or may be configured to operate one or more processors.

Accordingly, the term “part” or “unit” as an example includes: components such as software components, object-oriented software components, class components, and task components; and other components such as processes, functions, properties, procedures, subroutines, segments of program code, drivers, firmware, microcode, circuits, data, databases, data structures, tables, arrays, and variables. The components and functions provided in “parts” or “units” may be combined into a smaller number of components and “parts” or “units”, or further separated into additional components and “parts” or “units”.

Prior to the description of the present specification, some terms used in the present specification will be clarified. In the present specification, a high frequency component may be set to 150 kHz and a low frequency component may be set to 60 Hz, the high and low frequency components being determined on the basis of a battery capacity (e.g., 3 kW) for an electric vehicle, and an output signal means voltage and current. Accordingly, an output voltage, an output current, and the output signal will be used interchangeably.

Here, although an example describes that modules of respective phases for three-phase external power are provided, the same number of modules as the number of multi-phase external power may be provided. Accordingly, the number of phases and the number of modules for external power are not limited thereto.

With reference to the accompanying drawings, the exemplary embodiments of the present disclosure will be described in detail so that those skilled in the art can easily carry out the embodiments of the present invention. In addition, in order to clearly describe the present disclosure in the drawings, parts irrelevant to the description are omitted.

As an example, in the exemplary embodiment, a battery charger provided with a plurality of modules having a three-phase and single-phase single-stage structure is implemented to be compatible with three-phase or single-phase external power, so that external power in an alternating current form of single-phase or three-phase is converted into a direct current form, and charged to a battery.

Hereinafter, a single-phase and three-phase two-way battery charger according to an exemplary embodiment will be described with reference to the accompanying drawings.

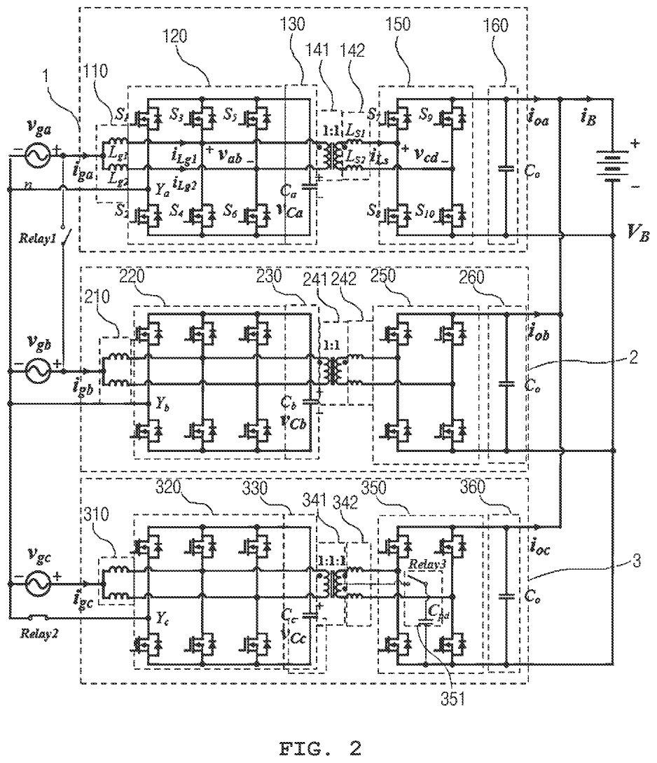

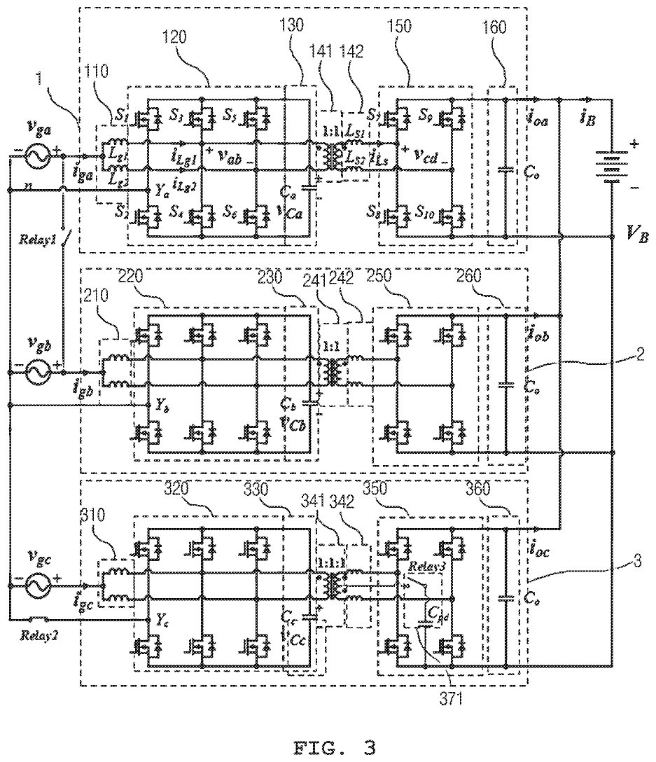

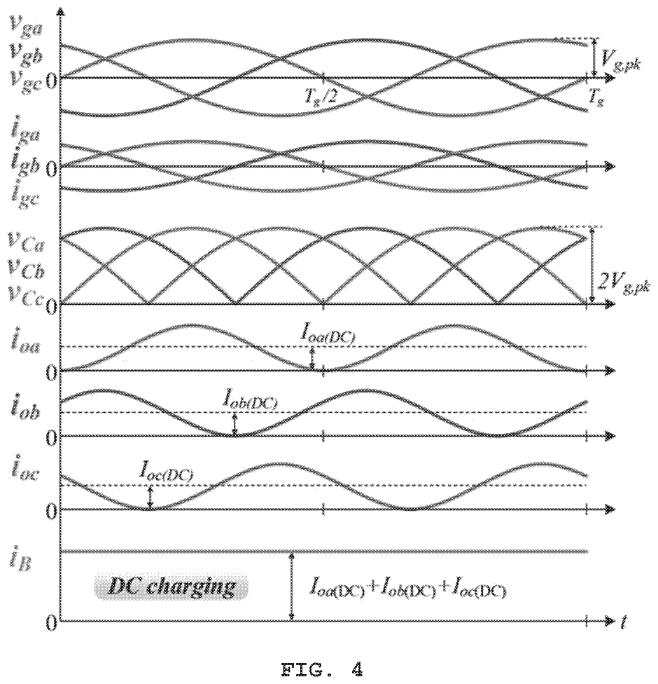

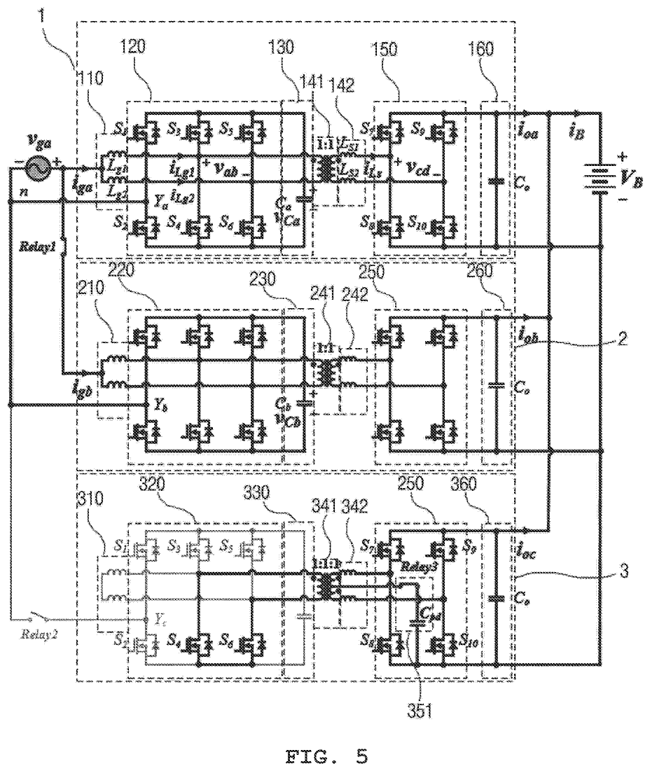

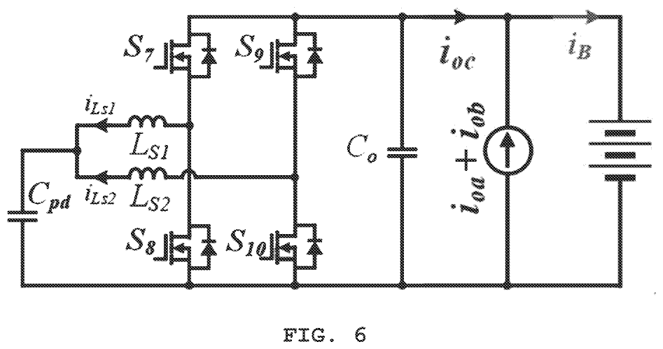

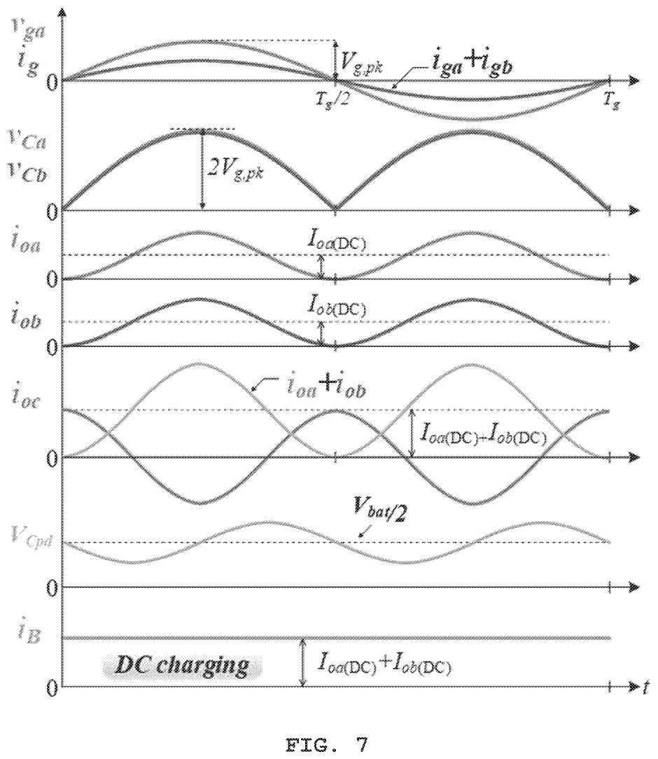

FIG. 2 is an overall configuration view of the charger according to the exemplary embodiment. FIG. 3 is a view illustrating an operation for three-phase external power supplies in the charger of FIG. 2. FIG. 4 is an output waveform diagram of each unit in FIG. 3. FIG. 5 is a view illustrating an operation for a single-phase external power supply in the charger of FIG. 2. FIG. 6 is an equivalent circuit diagram illustrating a third module of the charger of FIG. 5. FIG. 7 is an output waveform diagram of each unit in FIG. 5.

Referring to FIGS. 2 and 7, the single-phase and three-phase two-way battery charger of the present exemplary embodiment is provided so that modules 1, 2, and 3 are connected in parallel to respective three-phase external power v_{ga}, v_{gb}, and v_{gc} to convert external power of each phase into a direct current form. Accordingly, each of the modules 1, 2, and 3 includes: a first relay switch Relay1, a second relay switch Relay2, ripple removal units 110, 210, and 310, inverters 120, 220, and 320, rectifiers 130, 230, and 330, transformers 141, 241, and 341, noise removal units 142, 242, and 342, AC-DC converters 150, 250, and 350, and filters 160, 260, and 360.

Input terminals of the modules 1, 2, and 3 of respective phases connected to first ends of three-phase external power supplies v_{ga}, v_{gb}, and v_{gc} are provided with three input ports a, b, and c and corresponding neutral points n, and output terminals of the modules 1, 2, and 3 of respective phases are connected to a battery V_{B}. In addition, the second module 2 of the single-phase and three-phase two-way battery charger further includes a first relay switch Relay1 connected to a first end of an external power supply.

In addition, the third module 3 may further include: a second relay switch Relay2 connected to a first end of a single-phase or three-phase external power supply; and a decoupler 351 including a third relay switch Relay3 connected to a center tap of a secondary side of a transformer and an energy-regulating capacitor C_{pd}. Here, the respective three-phase external power v_{ga}, v_{gb}, and v_{gc} is alternating current power supplied with a phase difference of 120 degrees.

Accordingly, in the exemplary embodiment, for the three-phase external power v_{ga}, v_{gb}, and v_{gc}, the center tab of the transformer 341 and the battery are decoupled by the second relay switch Relay2 controlled to be closed, the first relay switch Relay1 and third relay switch Relay3, which are controlled to be opened, and the capacitor C_{pd}, so that the external power of each phase is converted into a direct current form of each phase, and then charged to the battery V_{B}.

In addition, in the exemplary embodiment, for the single-phase external power v_{ga}, the center tab of the transformer and the battery are operated to be decoupled by the first relay switch Relay1 and third relay switch Relay3, which are controlled to be closed, and the second relay switch Relay2 controlled to be opened, so that the single-phase external power is converted into a direct current form, and then charged to the battery V_{B}.

That is, the first relay switch Relay1 is connected between a first end of the single-phase external power supply and the second module 2 to supply single-phase AC power to the second module 2.

Meanwhile, the second relay switch Relay2 is connected between a second end of the external power supply and the third module 3 to supply single-phase external power to the third module 3.

Each of the modules 1, 2, and 3 has a configuration in which the external power v_{ga}, V_{gb}, and v_{gc} of respective phases supplied from the outside is transmitted through the first relay switch Relay1 and the second relay switch Relay2 and converted into a direct current form.

The ripple removal unit 110 of the module 1 has a configuration of which the inductors L_{g1} and L_{g2} are connected in parallel to respective external power v_{ga}, V_{gb}, and v_{gc}, and removes ripple components included in the external power v_{ga}, v_{gb}, and v_{gc} of respective phases.

Output terminals of the inductors L_{g1} and L_{g2} are connected to the inverter 120 of the module 1. The inverter 120 is provided with a plurality of switching elements S1 to S6 in parallel with output terminals of the inductors L_{g1} and L_{g2}. Each of the first and second switching elements S1 and S2, the third and fourth switching elements S3 and S4, and the fifth and sixth switching elements S5 and S6 is switched complementary to each other. Here, a connection structure of the plurality of switching elements S1 to S6 is already applied in battery chargers. The connection structure of the plurality of switching elements S1 to S6 is not specified in detail in the present specification, but should be understood at the standard of those skilled in the art.

In addition, the rectifier 130 of the module 1 is connected in parallel between an input terminal and an output terminal of the inverter 120, and the rectifier 130 is provided with a capacitor Cₐ. The rectification capacitor Cₐ clamps and half-wave rectifies an alternating current (AC) component included in an output signal of the inverter 120.

Meanwhile, each output terminal of the inverter 120 is connected to a primary side of the transformer 141 of the module 1. Accordingly, the transformer 141 passes an output signal of the rectification capacitor Cₐ and then transmits the output signal to the noise removal unit 142. The noise removal unit 142 removes a noise component included in the output signal of the transformer 141. Here, the transformer 141 includes: a transformer 141 having a 1:1 turns ratio; and inductors Lₛ₁ and Lₛ₂ of the noise removal unit 142, which are respectively connected to a first end and a second end of the transformer 141. As another example, an output signal of the rectification capacitor Cₐ may be amplified according to a turns ratio of a primary-side coil and a secondary-side coil of the transformer 141.

The AC-DC converter 150 of the module 1 is connected to each of output terminals of the inductors Lₛ₁ and Lₛ₂ of the noise removal unit 142, and the AC-DC converter 150 converts an output signal of a transformation unit 140 into a direct current form.

Here, the AC-DC converter 150 is provided with switching elements S7 to S10, and each of the seventh and eighth switching elements S7 and S8 and the ninth and tenth switching elements S9 and S10 is switched complementary to each other in accordance with switching signals of a controller (not shown).

Here, the switching signals of the controller may apply switching signals for receiving the current and voltage supplied to an already applied battery to operate the switching elements of the inverter and the switching elements of the AC-DC converter. Processes for deriving the switching signals of the controller are not specified in detail in the present specification, but should be understood at the standard of those skilled in the art.

Each output terminal of the AC-DC converter 150 of the module 1 is connected to the filter 160 of the module 1. The filter 160 is provided with a capacitor C_{O} connected between a first end and a second end of the AC-DC converter 150, removes a noise component included in an output signal of the AC-DC converter 150, and then transmits the output signal to the battery V_{B}.

Meanwhile, the module 2 has the same structure as that of the module 1 and includes: a ripple removal unit 210, an inverter 220, a rectifier 230, a transformer 241, a noise removal unit 242, an AC-DC converter 250, and a filter 260, so that the three-phase external input v_{gb} received by the first relay switch Relay1 controlled to be opened is converted into a direct current form and transmitted to the battery V_{B}.

The module 3 has the same structure as that of the module 1 and includes: a ripple removal unit 310, an inverter 320, a rectifier 330, a transformer 341, a noise removal unit 342, an AC-DC converter 350, and a filter 360, so that the three-phase external input v_{gc} received by the second relay switch Relay2 controlled to be closed is converted into a direct current form and transmitted to the battery V_{B}.

Accordingly, the connection structure for each of the modules 1, 2, and 3 is not specified in detail in the present specification, but should be understood at the standard of those skilled in the art.

In addition, the module 3 further has a configuration in which a decoupling operation between the center tap of the transformer and the filter 360 is performed on the basis of a third relay switch Relay3 controlled to be opened and a capacitor C_{pd}.

Hereinafter, an operation process of a single-phase and three-phase two-way charger will be described with reference to FIGS. 2 and 3 even in the case of three-phase external power.

That is, in the case of the three-phase external power v_{ga}, v_{gb}, v_{gc} supplied from the outside, a first relay switch Relay1 and a third relay switch Relay3 are controlled to be opened and a second relay switch Relay2 is controlled to be closed under the control of a controller (not shown).

Accordingly, the respective external power v_{ga}, v_{gb}, and v_{gc} of respective phases is transmitted to modules 1, 2, and 3, and output signals of the respective modules 1, 2, and 3 are superimposed and charged to a battery V_{B}. Describing the operation process of the module 1, the external power v_{ga} is caused to remove a ripple component thereof by a ripple removal unit 110, and then is transmitted to an inverter 120. In this case, the external power v_{ga} from which the ripple component is removed is a low frequency component.

In addition, the inverter 120 converts the external power v_{ga} of low frequency component from which the ripple has been removed into a high frequency component, and the converted output signal of high frequency component is transmitted to a rectifier 130. Accordingly, the output signal of high frequency component of the inverter 120 is half-wave rectified by a capacitor Cₐ of the rectifier 130.

Each output signal of the rectifier 130 is transmitted to a primary side of a transformer T1 of a transformation unit 140 of the module 1, and then excited to a secondary side of the transformer T1. Accordingly, output signals of the rectifier 130 are transmitted to noise removal inductors Lₛ₁ and Lₛ₂ via the transformer T1.

Noise components of the output signals of the transformer 141 are removed by the inductors Lₛ₁ and Lₛ₂ of a noise removal unit 142, and the output signals of the inductors Lₛ₁ and Lₛ₂ of high frequency component from which the noise components are removed are transmitted to an AC-DC converter 150.

The AC-DC converter 150 converts each of the output signals of the inductors Lₛ₁ and Lₛ₂ of high frequency component into a direct current form by operations of switching elements S7 to S10, the operations being performed by switching signals of a controller (not shown) supplied from the outside. Here, a noise component of each output signal of high frequency component in the direct current form is removed by a capacitor C_{O} of the filter 160, and an output signal of the capacitor C_{O} of the filter 160 is supplied to a battery V_{B}. Although not specified in detail in the present specification, the modules 2 and 3 operate in the same manner as that of the module 1.

In addition, in a decoupler 371 of the module 3, a center tap of a secondary side of the transformer 141 and the capacitor C_{O} of the filter 360 are decoupled by the relay switch Relay3 controlled to be opened by a control signal of the controller.

Referring to FIG. 4, it may be seen that a current i_{B} of a battery V_{B} of high frequency component with 150 kHz is generated due to superimposing of output currents i_{oa(DC)}, i_{ob(DC)} and i_{oc(DC)} for the respective modules 1, 2, and 3. In this case, a charging voltage of the battery may be 240V in a low frequency region and 400 to 800V in a high frequency region.

Meanwhile, referring to FIGS. 5 to 7, when connected to the single-phase external power v_{ga}, the first relay switch Relay1 and the third relay switch Relay3 are controlled to be closed and the second relay switch Relay2 is controlled to be opened according to control signals of the controller (not shown). Accordingly, the single-phase external power v_{ga} is transmitted to the module 2 via the first relay switch Relay1. The modules 1 and 2 convert the single-phase external power v_{ga} into a direct current form of high frequency component. Output signals of the respective modules 1 and 2 in the direct current form of high frequency component are superimposed and transmitted to a battery V_{B}.

The single-phase external power v_{ga} is transmitted to each of ripple removal units 110 and 210 of the modules 1 and 2, and each of the ripple removal units 110 and 210 removes a ripple component included in the single-phase external power v_{ga}.

In addition, output signals of the ripple removal units 110 and 210 are respectively transmitted to the inverters 120 and 220. The inverters 120 and 220 convert the external power v_{ga} of low frequency component into a high frequency component. The external power v_{ga} of high frequency component is transmitted to each of the capacitors Cₐ and C_{b} of respective rectifier 130 and 230, and is half-wave rectified.

The respective output signals of the capacitors Cₐ and C_{b} of such rectifiers 130 and 230 are transmitted to the transformers 141 and 241. The transformers 141 and 241 transmit the respective output signals of the capacitors Cₐ and C_{b} of the rectifiers 130 and 230 to the inductors Lₛ₁ and Lₛ₂ of the noise removal units 142 and 242 via a path from primary sides to secondary sides of the respective transformers 141 and 241. Accordingly, noise components included in the output signals of the transformers are removed.

In addition, the output signals of the respective transformers 141 and 241 of the modules 1 and 2 are converted into a direct current form by the AC-DC converters 150 and 250 of the modules 1 and 2, and then the output signals of the AC-DC converter 150 and 250 of high frequency component are transmitted to filters 160 and 260. The filters 160 and 260 remove noise components included in the output signals of the AC-DC converters 150 and 250 of high frequency component, and then transmit the output signals i_{oa(DC)} and i_{ob(DC)} to the battery V_{B}.

Meanwhile, as shown in FIG. 5, by the third relay switch Relay3 controlled to be closed, the charging voltage of the capacitor C_{O} of the filter 360 is discharged to the energy-regulating capacitor C_{pd} via the center tap of the secondary side of the transformer 341 in accordance with a switch operation of the seventh switching element S7, and a charging voltage of the energy-regulating capacitor C_{pd} is charged to the capacitor Cₒ of the filter 360 via the center tap of the secondary side of the transformer 341 in accordance with a switching operation of the tenth switching element S10. Here, the seventh switching element S7 and the tenth switching element S10 perform interleaving with a switching operation of mutual 180-degree phase shift in accordance with a control signal supplied from the outside.

Accordingly, being equivalent to an in-phase current source having with 120 Hz, the output signals of the module 1 and 2 become i_{oa(DC)}+i_{ob(DC)}, and as the fourth switching element S4 and sixth switching element S6 of the inverter 320 are short-circuited by the third relay switch Relay3 controlled to be closed, the equivalent impedance becomes 0. Accordingly, the AC-DC converter 350 of the module 3 is equivalent to a two-phase interleaved buck converter.

Accordingly, referring to FIG. 7, a current i_{B} of a battery V_{B} of high frequency component with 150 kHz is the sum of output currents i_{oa(DC)} and i_{ob(DC)} of the respective modules 1 and 2. Meanwhile, the charging voltage of the filter 360 of low frequency component is removed by the energy-regulating capacitor C_{pd}.

Accordingly, in the case of single-phase external power v_{gc}, a current rating of the capacitor C_{pd} may be reduced due to the interleaved operations of secondary-side inductors Lₛ₁ and Lₛ₂ of the transformer 341, the capacitor C_{pd}, and the seventh to tenth switching elements S7 to S10 of the AC-DC converter 350 in the module 3.

In addition, efficiency may be maximally increased as the seventh to tenth switching elements S7 to S10 perform zero voltage switching (ZVS) in a high-frequency switching operation, and accordingly, a direct current component of the battery may be charged because a current of 120 Hz is removed in 3 kW operation.

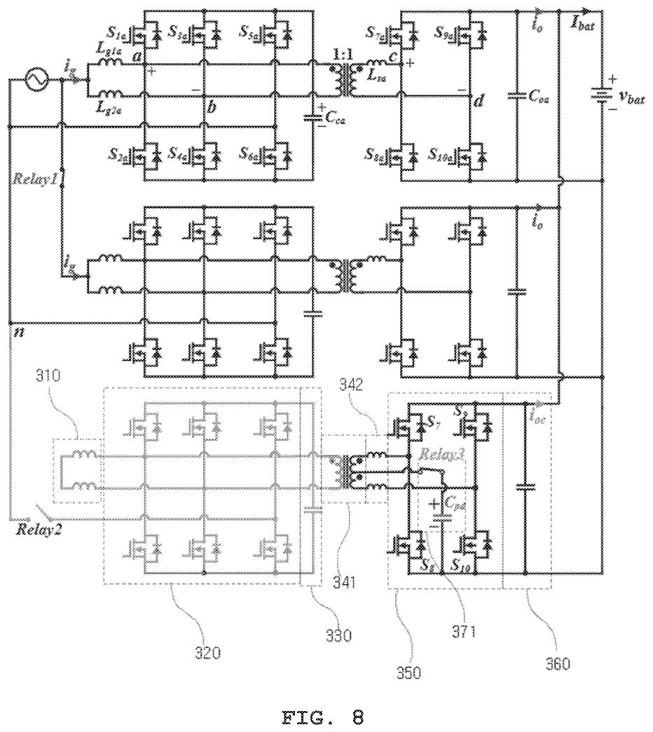

FIG. 8 is a view illustrating an operation process of the decoupler 351 of FIG. 5. Referring FIG. 8, by the third relay switch Relay3 controlled to be closed, the charging voltage of the capacitor C_{O} of the filter 360 is discharged to the energy-regulating capacitor C_{pd} via the center tap of the transformer 341 in accordance with a switch operation of the secondary side of the seventh switching element S7, and the charging voltage of the energy-regulating capacitor C_{pd} is charged to the capacitor C_{O} of the filter 360 via the center tap of the secondary side of the transformer 341 in accordance with a switching operation of the tenth switching element S10.

Here, since the interleaving is performed with the same-phase switching operation in the seventh switching element S7 and the tenth switching element S10, there is no potential difference between the first end and the second end of the secondary side of the transformer 340, so the transformer 340 is deactivated.

Accordingly, being equivalent to an in-phase current source with 120 Hz, the output signals of the module 1 and 2 become i_{oa(DC)}+i_{ob(DC)}, and the charging voltage of the filter 360 of low frequency component is removed by the energy-regulating capacitor C_{pd}.

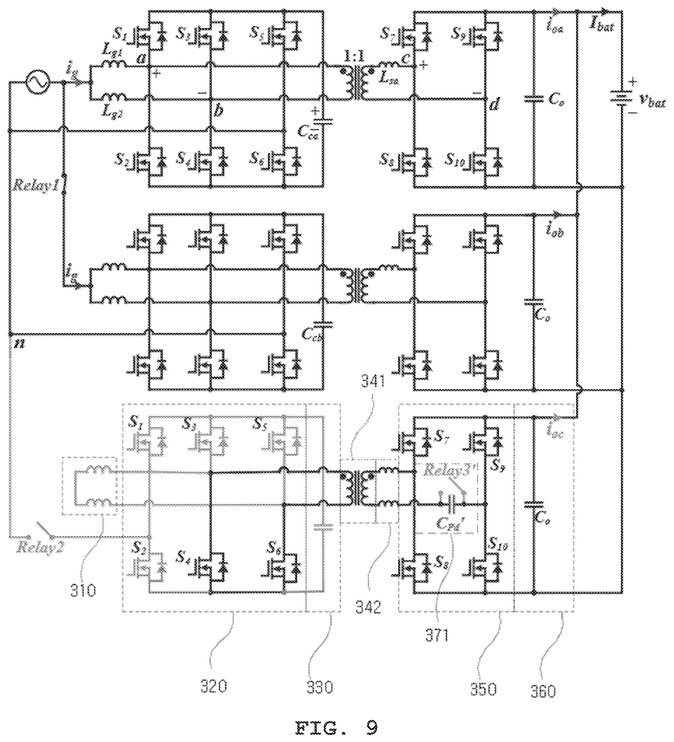

FIG. 9 is another exemplary view illustrating the decoupler 371 shown in FIG. 5. Referring to FIG. 9, the decoupler 371 has a configuration including: a third relay switch Relay3′ having a first end thereof connected to a secondary side of a transformer 341 to decouple an output terminal of a secondary-side of the transformer 341 and a battery V_{B} when external power is cut off with a single-phase input; and an energy-regulating capacitor C_{pd}′ connected between a second end of the secondary side of the transformer 341 and a second end of the third relay switch Relay3′ to remove a charging voltage of a filter 360.

Accordingly, by the third relay switch Relay3′ controlled to be closed, a charging voltage of the capacitor C_{O} of the filter 360 is discharged to the energy-regulating capacitor C_{pd}′ via the first end of the secondary side of the transformer 341 in accordance with a switch operation of the seventh switching element S7 of the AC-DC converter 350, and a charging voltage of the energy-regulating capacitor C_{pd}′ is charged to the capacitor C_{O} of the filter 360 via the second end of the secondary side of the transformer 341 in accordance with a switching operation of the tenth switching element S10.

Here, the seventh switching element S7 and tenth switching element S10 of the AC-DC converter 350 perform interleaving with a switching operation of mutual 180-degree phase shift. Accordingly, being equivalent to an in-phase current source with 120 Hz, the output signals of the module 1 and 2 become i_{oa(DC)}+i_{ob(DC)}, and as the fourth switching element S4 and sixth switching element S6 of the inverter 320 are short-circuited by the third relay switch Relay3′ controlled to be closed, the equivalent impedance becomes 0, and accordingly, the transformer 341 is deactivated, whereby the AC-DC converter 350 of the module 3 is equivalent to a two-phase interleaved buck converter.

Meanwhile, a current i_{B} of the battery V_{B} of high frequency component with 150 kHz is the sum of output currents i_{oa(DC)} and i_{ob(DC)} of the respective modules 1 and 2. Meanwhile, the charging voltage of low frequency component of the filter 360 is removed by the energy-regulating capacitor C_{pd}′.

Accordingly, in the case of single-phase external power v_{gc}, a current rating of the capacitor C_{pd}′ may be reduced due to the interleaved operation of secondary-side inductors Lₛ₁ and Lₛ₂ of the transformer 341, the capacitor C_{pd}′, and the seventh to tenth switching elements S7 to S10 of the AC-DC converter 350 in the module 3.

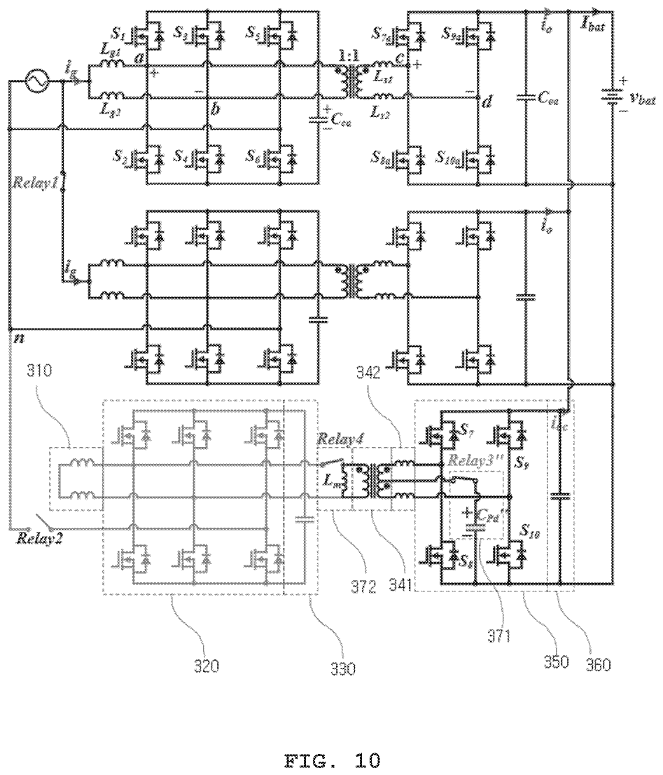

FIG. 10 is another exemplary view illustrating the third module 3 shown in FIG. 2. Referring to FIG. 10, the third module 3 includes: a decoupler 371 for controlling an output signal of a filter 360 for single-phase external power; and a transformer relay unit 372 connected between an output terminal of a ripple removal unit 310 and a second end of a primary side of a transformer 341.

Here, the decoupler 371 is provided to include: a third relay switch Relay3″ connected in series to a center tap of a secondary side of the transformer 341 to decouple an output terminal of the secondary side of the transformer 341 and a battery V_{B} when single-phase external power is cut off; and an energy-regulating capacitor C_{pd}″ for charging and discharging a charging voltage of the filter 360 of low frequency component.

In addition, the transformer relay unit 372 has a configuration including: a fourth relay switch Relay 4 connected in series between an output terminal of an inductor L_{g1} of a ripple removal unit 310 and a first end of the primary side of the transformer 341; and a decoupling inductor Lₘ connected between an output terminal of the fourth relay switch Relay4 and the second end of the primary side of the transformer 341.

Accordingly, by the third relay switch Relay3″ controlled to be closed, a charging voltage of a capacitor C_{O} of the filter 360 is discharged to the energy-regulating capacitor C_{pd}″ via a first end of the secondary side of the transformer 341 in accordance with a switch operation of a seventh switching element S7 of an AC-DC converter 350, and a charging voltage of the energy-regulating capacitor C_{pd}″ is charged to the capacitor C_{O} of the filter 360 via a second end of the secondary side of the transformer 341 in accordance with a switching operation of a tenth switching element S10.

Meanwhile, the fourth relay switch Relay 4 of the transformer relay unit 372 is controlled to be closed in accordance with a control signal, and accordingly, an output signal of the primary side of the transformer 341 is transmitted to the ripple removal unit 310 via the inductor Lₘ and the fourth relay switch Relay 4.

Accordingly, the output signals of the modules 1 and 2 is equivalent to an in-phase current source with 120 Hz to become i_{oa(DC)}+i_{ob(DC)}. Accordingly, since the primary-side excited output signal of the transformer 341 is transmitted to the ripple removal unit 310 via the inductor Lₘ of the transformer relay unit 372 and the fourth relay switch Relay 4, the transformer 341 is deactivated. Thus, the AC-DC converter 350 of the module 3 is equivalent to a two-phase interleaved buck converter.

Meanwhile, a current i_{B} of the battery V_{B} of high frequency component with 150 kHz is the sum of output currents i_{oa(DC)} and i_{ob(DC)} of the respective modules 1 and 2. Meanwhile, a charging voltage of the filter 360 of low frequency component is removed by the energy-regulating capacitor C_{pd}″.

Accordingly, in a case of single-phase external power v_{gc}, a current rating of the capacitor C_{pd}″ may be reduced due to the interleaved operation of secondary-side inductors Lₛ₁ and Lₛ₂ of the transformer 341, the capacitor C_{pd}″, and the seventh to tenth switching elements S7 to S10 of the AC-DC converter 350 in the module 3.

According to the exemplary embodiment, the single-phase and three-phase two-way battery charger with the AC-DC converter in the single-stage structure is implemented without electrolytic capacitors that reduce reliability and charging efficiency, so compatibility with single-phase and three-phase external power may be provided and the number of switching elements is reduced, whereby charging efficiency and performance over a wide input/output voltage range may be improved and reliability and a service life may be improved.

Meanwhile, in the exemplary embodiment, at least two among each inductor L_{g1} and L_{g2} of the ripple removal unit 110, the transformer 141, and the inductors Lₛ₁ and Lₛ₂ of the noise removal unit 142 in the module 1 may be fabricated into one integrated-type core.

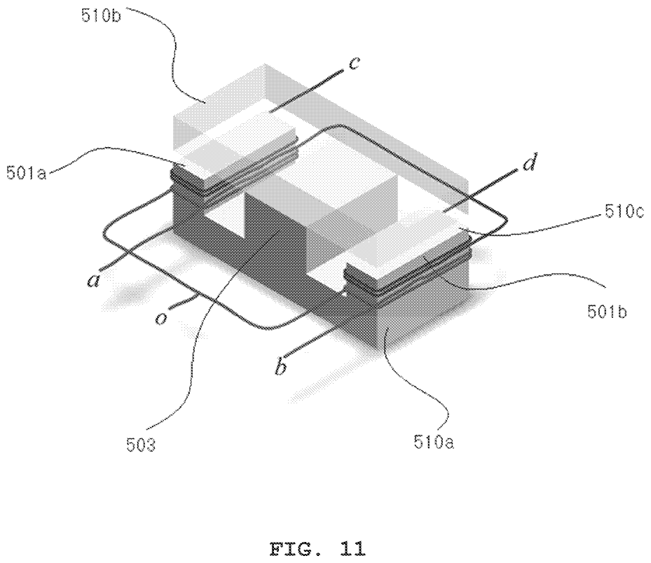

FIGS. 11 to 14 are views each illustrating a configuration of one integrated core that is fabricated with the inductors L_{g1} and L_{g2} of the ripple removal unit 110, the primary and secondary sides of the transformer 141 of the transformation unit 140, and the inductors Lₛ₁ and Lₛ₂ of the noise removal unit 142 in the module 1.

Referring to FIG. 11, in an example, a core includes: a lower plate 510a integrally molded with three legs, such as both-side legs 501a and 501b and a center leg 503; and an upper plate 510b attached to the center leg 503 and connected to the lower plate 510a.

In addition, the inductors L_{g1} and L_{g2} of the ripple removal unit 110 have respective coils wound on lower surfaces of the both-side legs 501a and 501b, and the primary and secondary sides of the transformer 141 have respective coils wound on upper surfaces of the both-side legs 501a and 501b. Accordingly, the inductors L_{g1} and L_{g2} of the ripple removal unit 110 and the primary and secondary sides of the transformer 141 may be implemented by one integrated core.

In addition, a first end of a primary-side winding of the transformer 141 is connected to an output terminal of the inductor L_{g1} and an output terminal of the switching element S4 through a node a and a node o, and a second end of the primary-side winding of the transformer 141 is connected to an output terminal of the inductor L_{g2} and an input terminal of the switching element S6 through a node b and the node o. Here, the node o is the ground of external power.

Meanwhile, first and second ends of a secondary-side winding of the transformer are respectively connected in series to the inductor Lₛ₁ and inductor Lₛ₂ through nodes c and d, and an air gap 510c may be formed in at least one of the both-side legs 501a and 501b of the lower plate 510a and the center leg 503, and the air gap controls inductance and prevents magnetic flux saturation of the upper and lower plates 510a and 510b of a magnetic body.

Accordingly, in the exemplary embodiment, the inductors L_{g1} and L_{g2} of the ripple removal unit 110 and the primary and secondary sides of the transformer 141 are fabricated into one integrated-type core, whereby a lightweight charger may be provided.

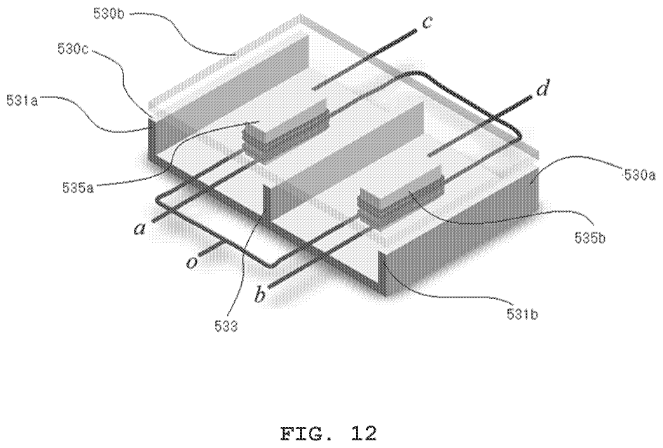

Referring to FIG. 12, as another example, a core has a configuration including: a lower plate 530a integrally molded with both-side legs 531a and 531b, a center leg 533, and winding legs 535a and 535b between the both-side legs 531a and 531b and the center leg 533; and an upper plate 530b attached to the center leg 533 and connected to the lower plate 530a.

In addition, the inductors L_{g1} and L_{g2} of the ripple removal unit 110 have respective coils wound on lower sides of the winding legs 535a and 535b of the lower plate 530a. The primary side and the secondary side of the transformer 141 have respective coils wound on upper sides of the winding legs 535a and 535b of the lower plate 530a. An air gap 530c is formed in at least one of the winding legs 535a and 535b and the both-side legs 531a and 531b between the upper and lower plates 530a and 530b. The air gap 530c controls inductance and prevents magnetic flux saturation of the upper and lower plates 530a and 530b of a magnetic body.

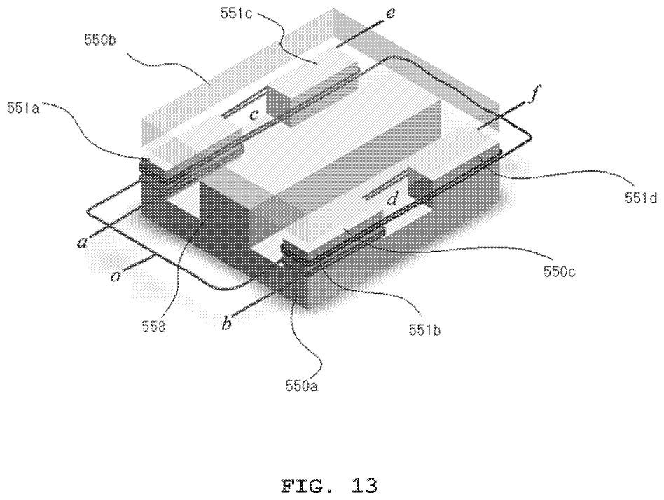

Referring to FIG. 13, according to a yet another example, a core includes: a lower plate 550a integrally molded with both-side front legs 551a and 551b, both-side rear legs 551c and 551d, and one center leg 553; and an upper plate 550b attached to the center leg 553 and connected to the lower plate 550a.

An air gap 550c is formed in at least one of the both-side front legs 551a and 551b, the both-side rear legs 551c and 551d, and the center leg 553 of the lower plate 550a, thereby controlling inductance and preventing magnetic flux saturation of the upper and lower plates 530a and 530b of a magnetic body.

In addition, the inductors L_{g1} and L_{g2} of the ripple removal unit 110 have respective coils wound on lower sides of the both-side front legs 551a and 551b of the lower plate 550a. The primary side and the secondary side of the transformer 141 have respective coils wound on upper sides of the both-side front legs 551a and 551b of the lower plate 550a. The inductors Lₛ₁ and Lₛ₂ of the ripple removal unit 142 connected to the secondary side of the transformer may have respective coils wound on the both-side rear legs 551c and 551d of the lower plate 550a.

A first end of a primary-side winding of the transformer 141 is connected to an output terminal of the inductor L_{g1} and an output terminal of the switching element S4 through a node a and a node o, and a second end of the primary-side winding of the transformer 141 is connected to an output terminal of the inductor L_{g2} and an input terminal of the switching element S6 through a node b and the node o. Here, the node o is the ground of external power.

Meanwhile, a first end c and a second end d of a secondary-side winding of the transformer 141 are respectively connected in series to the inductor Lₛ₁ and the inductor Lₛ₂ through nodes e and f, so that the inductors L_{g1} and L_{g2} of the ripple removal unit 110, the transformer 141, and the inductors Lₛ₁ and Lₛ₂ of the noise removal unit 142 are integrated into one core.

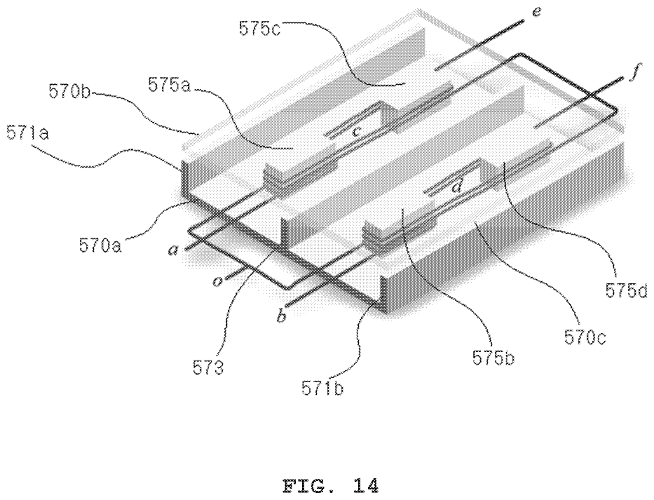

Referring to FIG. 14, in another example, a core has a configuration including: a lower plate 570a integrally molded with both-side legs 571a and 571b, a center leg 573, and front winding legs 575a and 575b and rear winding legs 575c and 575d between the both-side legs 571a and 571b and the center leg 573; and an upper plate 570b attached to the center leg 573 and connected to the lower plate 570a.

In addition, the inductors L_{g1} and L_{g2} of the ripple removal unit 110 have respective coils wound on lower sides of the front winding legs 575a and 575b of the lower plate 570a. The primary side and the secondary side of the transformer 141 have respective coils wound on upper sides of the front winding legs 575a and 575b and rear winding legs 575c and 575d of the lower plate 570a. An air gap 570c is formed in at least one of the both-side legs 571a and 571b, the center leg 573, and the front winding legs 575a and 575b and the rear winding legs 575c and 575d between the upper and lower plates 570a and 570b. The air gap 570c controls inductance and prevents magnetic flux saturation of the upper and lower plates 570a and 570b of a magnetic body.

The exemplary embodiment may obtain strong points applicable to a lightweight charger in terms of price and volume by means of one integrated core.

The present disclosure has been described with reference to the exemplary embodiments shown in the drawings, but these are only exemplary, and those skilled in the art will appreciate that various modifications and other equivalent embodiments are possible. Therefore, the technical protective scope of the present disclosure will be defined by the claims below.

### INDUSTRIAL APPLICABILITY

A single-phase and three-phase two-way battery charger having a single-stage structure is implemented without electrolytic capacitors that reduce reliability and charging efficiency, whereby compatibility with single-phase and three-phase external power may be provided, charging efficiency and performance over a wide input/output voltage range may be improved due to the reduced number of switching elements and soft switching operation of the switching elements, and reliability and a service life may be improved. As for the single-phase and three-phase two-way charger that may implement a lightweight charger by integrating, into one core, at least two of the ripple removal inductor of the battery charger, the primary side and the secondary side of the transformer, and the noise removal inductor, the present disclosure may bring about great progress in terms of operational accuracy and reliability, and may further provide performance efficiency. In addition, the embodiments of the present disclosure not only has sufficient potential for marketing or sales of electric vehicle charger, but also has capabilities to the extent that the embodiments may be clearly implemented in reality, thereby having industrial applicability.

1. A three-phase and single-phase two-way charger, the charger comprising:
first to third modules configured to convert respective three-phase external power into a high-voltage direct current form and then charge a battery, with respect to the three-phase external power, and further comprising:
a first relay switch for transmitting single-phase external power to the second module with respect to the single-phase external power; and
a second relay switch for blocking the transmitting of the single-phase external power to the third module with respect to the single-phase external power.

2. The charger of claim 1, wherein the three-phase and single-phase two-way charger is provided to supply the respective three-phase external power to each of the first to third modules by the first relay switch controlled to be opened and the second relay switch controlled to be closed with respect to the three-phase external power, and is provided to supply the single-phase external power to each of the first to second modules and to block the supply of the single-phase external power to the third module by the first relay switch controlled to be closed and the second relay switch controlled to be opened with respect to the single-phase external power.

3. The charger of claim 1, wherein each of the modules comprises:
a ripple removal unit provided with inductors connected in parallel to a first end of an external power supply, which is supplied through the first and second relay switches, to remove a ripple component of the external power;
an inverter connected to an output terminal of the ripple removal unit to convert the external power of low frequency component into an alternating current form of high frequency component;
a capacitor for half-wave rectifying an alternating current component of an output signal of the inverter;
a transformer connected to an output terminal of the capacitor to pass an output signal of the capacitor;
a noise removal unit provided with inductors respectively connected to a first end and a second end of a secondary side of the transformer to remove a noise component included in an output signal of the secondary side of the transformer;
an AC-DC converter connected to an output terminal of each inductor of the noise removal unit to convert an output signal of each inductor into the direct current form; and
a filter provided as a capacitor connected between a first end and a second end of the AC-DC converter to remove a noise component included in an output signal of the AC-DC converter and then charge the output signal of high frequency component to the battery.

4. The charger of claim 3, wherein the third module further comprises:
a decoupler for controlling an output signal of the filter with respect to the single-phase external power, and
the decoupler comprises:
a third relay switch connected in series to a center tap of the secondary side of the transformer to decouple an output terminal of the secondary side of the transformer and the battery; and
an energy-regulating capacitor for charging and discharging a low frequency component of the output signal of the filter.

5. The charger of claim 4, wherein, in the decoupler, the output signal of the filter of the third module is supplied to the battery by the third relay switch controlled to be opened in accordance with a control signal supplied from an outside with respect to the three-phase external power.

6. The charger of claim 4, wherein the decoupler is provided to remove a charging voltage of the filter and deactivate the transformer in accordance with a short circuit of switching elements of the inverter as the third relay switch is controlled to be closed in accordance with a control signal supplied from an outside with respect to the single-phase external power and the charging voltage of the filter is transmitted to the energy-regulating capacitor via the AC-DC converter performing interleaving with a switching operation of 180-degree phase shift.

7. The charger of claim 4, wherein the decoupler is provided to remove a charging voltage of the filter of low frequency component and deactivate the transformer in accordance with a same-phase switching operation of the AC-DC converter as the third relay switch is controlled to be closed in accordance with a control signal supplied from an outside with respect to the single-phase external power and the output signal of the filter is transmitted to the energy-regulating capacitor via the AC-DC converter performing interleaving with the same-phase switching operation.

8. The charger of claim 4, wherein the decoupler comprises:
the third relay switch connected to the first end of the secondary side of the transformer to decouple the output terminal of the secondary side of the transformer and the battery when the external power is cut off with a single-phase input; and
the energy-regulating capacitor connected between the second end of the secondary side of the transformer and a second end of the third relay switch to remove a charging voltage of the filter, and
the decoupler is provided to remove the charging voltage of the filter and deactivate the transformer in accordance with a short circuit of switching elements of the inverter as the third relay switch is controlled to be closed in accordance with a control signal supplied from an outside with respect to the single-phase external power and the charging voltage of the filter is transmitted to the energy-regulating capacitor via the switching elements of the AC-DC converter.

9. The charger of claim 3, wherein the third module comprises:
a decoupler for controlling the output voltage of the filter with respect to the single-phase external power; and
a transformer relay unit connected between the output terminal of the ripple removal unit and a second end of a primary side of the transformer.

10. The charger of claim 9, wherein the decoupler comprises:
the third relay switch connected in series to a center tap of the secondary side of the transformer to decouple the output terminal of the secondary side of the transformer and the battery; and
the energy-regulating capacitor for charging and discharging a low frequency component of the output signal of the filter, and
the transformer relay unit comprises:
a fourth relay switch connected in series between an output terminal of the ripple removal unit and a first end of the primary side of the transformer; and
an inductor connected between the output terminal of the fourth relay switch and the second end of the primary side of the transformer.

11. The charger of claim 10, wherein the decoupler is provided to remove a charging voltage of the filter as the third relay switch is controlled to be closed in accordance with a control signal supplied from an outside with respect to the single-phase external power and the charging signal of the filter is transmitted to the energy-regulating capacitor via the AC-DC converter performing the interleaving with a switching operation of 180-degree phase shift, and
the transformer relay unit is provided to deactivate the transformer as the fourth relay switch is switched to a closed state in accordance with the control signal with respect to the single-phase external power and an output signal of the primary side of the transformer is transmitted to the ripple removal unit via the inductors and the fourth relay switch.

12. The charger of claim 3, wherein each of the modules is provided with one core formed by integrating, into a pair of plates made of a magnetic material, at least two of the inductors of the ripple removal unit, the primary side and the secondary side of the transformer, and the inductors of the noise removal unit.

13. The charger of claim 12, wherein the core is provided with the pair of plates comprising a lower plate integrally molded with both-side legs and a center leg respectively installed on both sides and in a center thereof and an upper plate attached to the center leg and connected to the lower plate to form a magnetic body, and is provided so that the inductors of the ripple removal unit have coils respectively wound on lower sides of the both-side legs of the lower plate and the primary side and secondary side of the transformer have coils respectively wound on upper sides of the both-side legs of the lower plate.

14. The charger of claim 12, wherein the core is provided with a pair of plates configured to form a magnetic body by comprising a lower plate integrally molded with both-side legs, a center leg, and winding legs between the both-side legs and the center leg and an upper plate attached to the center leg and connected to the lower plate, and is provided so that the inductors of the ripple removal unit have coils respectively wound on lower sides of the winding legs of the lower plate and the primary side and the secondary side of the transformer have coils respectively wound on upper sides of the winding legs of the lower plate.

15. The charger of claim 12, wherein the core is provided with a pair of plates comprising a lower plate integrally molded with both-side front legs, both-side rear legs, and one center leg and an upper plate attached to the center leg and connected to the lower plate, and is provided so that the inductors of the ripple removal unit have coils respectively wound on lower sides of the both-side front legs of the lower plate, the primary side and the secondary side of the transformer have coils respectively wound on upper sides of the both-side front legs of the lower plate, and the inductors of the noise removal unit connected to the secondary side of the transformer have coils respectively wound on the both-side rear legs of the lower plate.
